(19) United States
(12) Patent Application Publication
(10) Pub. No.: US 2026/0150868 A1
(43) Pub. Date: Jun. 4, 2026

(54) SYSTEM AND METHOD FOR MANAGING A POPCORN POPPING PROCESS

(71) Applicant: Gold Medal Products Co., Cincinnati, OH (US)

(72) Inventors: Matthew A. Weber, Springboro, OH (US); Todd M. Kroeger, West Chester, OH (US)

(21) Appl. No.: 19/408,987

(22) Filed: Dec. 4, 2025

Related U.S. Application Data
(60) Provisional application No. 63/728,153, filed on Dec. 4, 2024.

(51) Int. Cl. A23L 7/187; G01K 3/00; G04F 10/00; G05D 3/12

(52) U.S. Cl. CPC A23L 7/187; G01K 3/005; G04F 10/00; G05D 3/125

(57) ABSTRACT

A popcorn machine is provided herein. The popcorn machine comprises a kettle configured to cook popcorn kernels, a heater configured to heat the kettle, a first sensor configured to detect a first operational parameter during cooking of the popcorn kernels, a second sensor configured to detect a second operational parameter during cooking of the popcorn kernels, a drive assembly operatively coupled to the kettle and configured to automatically dump the kettle, and a controller communicatively coupled to the first sensor, the second sensor, and the drive assembly. The controller is configured to compare the first operational parameter to a first threshold value, compare the second operational parameter to a second threshold value, and activate the drive assembly to automatically dump the kettle when both the first operational parameter satisfies the first threshold value and the second operational parameter satisfies the second threshold value.

### REFERENCE TO RELATED APPLICATIONS

This application claims priority of U.S. provisional patent application Ser. No. 63/728,153, entitled SYSTEM AND METHOD FOR MANAGING A POPCORN POPPING PROCESS, filed Dec. 4, 2024, and hereby incorporates this patent application by reference herein in its entirety.

### TECHNICAL FIELD

The apparatus and methods described below generally relate to a popcorn machine with an automated dumping system that monitors popping conditions to determine completion of the popping process. The popcorn machine includes a controller that monitors both the popping rate of kernels and the temperature of a kettle to automatically initiate a dumping sequence when predetermined threshold conditions are satisfied.

### BACKGROUND

Popcorn popping machines are widely used in commercial and residential settings to produce popped popcorn for consumption. These machines typically include a kettle 18 that is heated to pop kernels of corn, and the kettle 18 is often pivotably mounted to allow for dumping of the popped popcorn into a collection area. Conventional popcorn popping processes rely on predetermined time and temperature parameters to determine when the popping process is complete, but these methods can be imprecise due to variations in factors such as humidity, type of corn, age of corn, and ambient conditions. Users typically must monitor the popping process manually by listening for auditory cues from the popping kernels to determine when the process is complete, which can be time-consuming and can result in inconsistent product quality. Additionally, conventional machines require manual operation for dumping the kettle 18, which can expose operators to hot surfaces and requires constant attention throughout the popping cycle. While some conventional popcorn machines have attempted to address these limitations by incorporating pop rate monitoring systems, these systems rely on a single parameter for determining completion and can result in inconsistent product quality.

### BRIEF DESCRIPTION OF THE DRAWINGS

Various embodiments will become better understood with regard to the following description, appended claims and accompanying drawings wherein:

FIG. 1 is a front perspective view depicting a popcorn machine;

FIG. 2 is an enlarged front elevation view of the popcorn machine of FIG. 1;

FIG. 3 is a cutaway view of a drive assembly for the popcorn machine of FIG. 1;

FIG. 4 is a system diagram of a popcorn cooking system of the popcorn machine of FIG. 1;

FIG. 5 is a flowchart of an operational process for the popcorn machine of FIG. 1; and

FIG. 6 is a flowchart of a safety process for the popcorn machine of FIG. 1.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The examples discussed herein are examples only and are provided to assist in the explanation of the apparatuses, devices, systems and methods described herein. None of the features or components shown in the drawings or discussed below should be taken as mandatory for any specific implementation of any of the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Described herein are one or more example embodiments of a kettle-style popcorn machine that includes a popcorn cooking system having a kettle and a controller. The popcorn cooking system implements a cooking sequence followed by an automated dumping sequence. During the cooking sequence, the kettle is heated and raw product, such as popcorn kernels and cooking oil, are introduced into the kettle. A controller or similar device can then monitor one or more operational parameters of the popping popcorn, such as the pop rate of the popcorn and the heat profile of the kettle, to determine whether those operational parameters indicate that the popcorn has been sufficiently popped. Once the controller is satisfied that the popcorn has been sufficiently popped, the automated dumping sequence is implemented to facilitate automated dumping of the contents of the kettle onto a tray below.

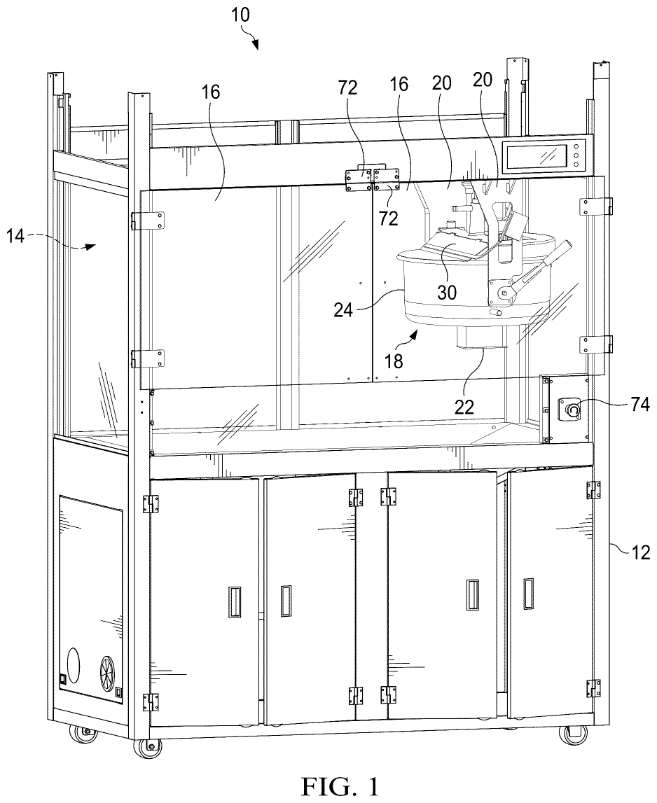

Referring to FIG. 1, a popcorn machine 10 is illustrated and is shown to include a housing 12 that provides structural support and encloses various components of the popcorn machine 10. The housing 12 can be constructed from durable materials suitable for commercial food service applications and can define the overall framework of the popcorn machine 10. The housing 12 can define a popping chamber 14 that serves as an enclosed space where the popcorn popping process occurs. The popping chamber 14 can be accessible through access doors 16 that are located on the front of the housing 12. The access doors 16 can allow users to access the popping chamber 14 for loading ingredients such as unpopped kernels and oil, and for retrieving popped popcorn after the cooking process is complete.

A kettle 18 can be disposed in the popping chamber 14 and configured to facilitate cooking of popcorn. The kettle 18 can be constructed from materials with good thermal conductivity, such as stainless steel or aluminum, to facilitate efficient heat transfer during the popping process. The kettle 18 can include a heater 22 that is associated with a bowl 24. The bowl 24 can be configured to contain the kernels and oil during the cooking process. The heater 22 can imparts thermal energy to the bowl 24 to facilitate cooking of the popcorn. The heater 22 can be an electric heating element that can be integrated into or mounted on the kettle 18 to provide direct heating of the kettle 18 contents. The heater 22 can utilize conductive heating, where heat is transferred through direct contact with the kettle 18, or can utilize inductive heating, where heat is generated through electromagnetic induction within the kettle 18 material.

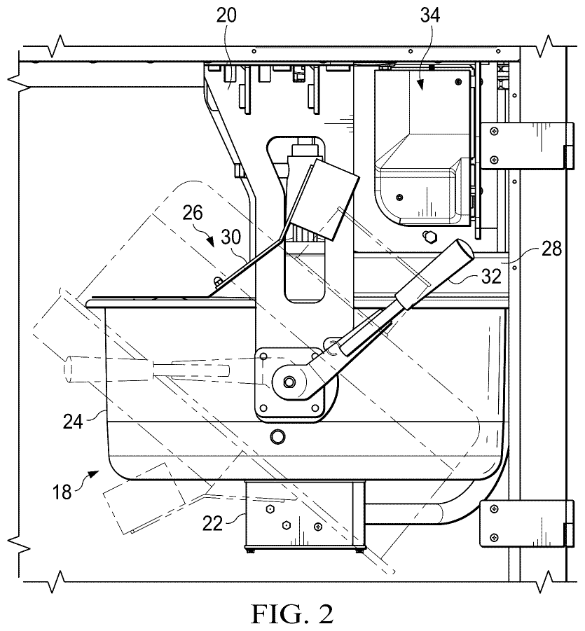

Referring now to FIG. 2, the kettle 18 can be suspended within the popping chamber 14 by a pair of arms 20 and can be pivotable relative to the arms 20 between home position (shown in solid lines) and a dumping position (shown in dashed lines). The kettle 18 can be provided in the home position during the popping process and can be moved to the dumping position to dispense popped popcorn from the kettle 18 onto an underlying tray. A lid 26 can be provided over the bowl 24 and can include a fixed panel 28 and a pivotable panel 30 that is pivotable between an opened position and a closed position (not shown). When the kettle 18 is in the home position, the pivotable panel 30 can be pivotable between the opened position, to provide access to the bowl 24, and the closed position, to cover the bowl 24, during the cooking process. When the kettle 18 is moved to the dumping position, the pivotable panel 30 can be pivoted into the opened position (due to gravity) to allow the contents of the bowl 24 to be emptied.

A handle 32 can be operably coupled with the kettle 18 to allow for manual tilting of the kettle 18 between the home position and the dumping position. In some instances, the handle 32 can provide a means for manually pivoting the kettle 18 between the home and dumping positions when automatic operation may not be desired or available. The popcorn machine 10 can include a drive assembly 34 that is operably coupled with the kettle 18 and can facilitate powering of the kettle 18 between the home position and the dumping position. The drive assembly 34 can provide automated control of the pivoting motion of the kettle 18 in scenarios where manual pivoting of the kettle 18 is not desired such as during automatic dumping sequences.

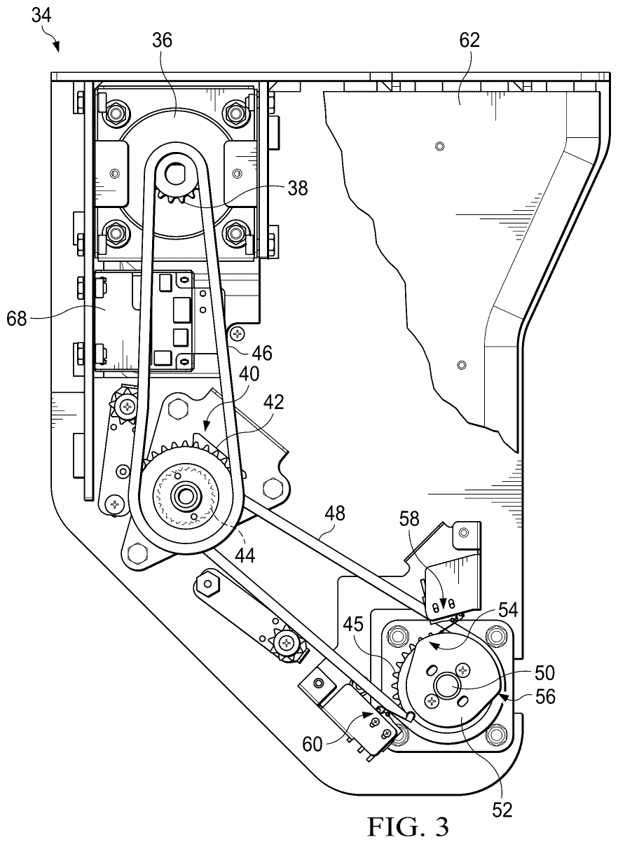

Referring now to FIG. 3, the drive assembly 34 can include a motor 36 that provides rotational power for pivoting the kettle 18 between the home position and the dumping position. The motor 36 can be operatively connected to a drive gear 38 that receives rotational motion from the motor 36. The drive gear 38 can engage with an intermediate drive 40 through a drive chain 46 that transmits the rotational motion from the motor 36 to the intermediate drive 40. The intermediate drive 40 can include an intermediate drive gear 42 and an intermediate driven gear 44 that are mechanically coupled together. The intermediate drive gear 42 can engage the drive chain 46 to receive rotational motion therefrom. The intermediate driven gear 44 can transmit the rotational motion from the intermediate drive 40 to a driven gear 45 via a driven chain 48. The driven gear 45 can be mounted to a spindle 50 of the kettle 18. The spindle 50 can support the kettle 18 relative to the arms 20 and can facilitate pivoting of kettle 18 between the home position and the dumping position. The drive assembly 34 can accordingly facilitate automated pivoting of the kettle 18 through coordinated operation of the motor 36, gears, and chains. The drive assembly 34 can be enclosed and protected by a cover 62 that allows access for maintenance when needed.

In some instances, the motor 36 can include position detection functionality that allows for the specific angular position of a shaft of the motor 36 to be monitored during operation in order to determine the position of the kettle 18. For example, the motor 36 can be an AC stepper motor that enables monitoring of the number of pulses sent to the motor 36 to determine the specific angular position of the shaft of the motor 36. Alternatively, the motor 36 can be a DC motor that includes an encoder or other position-sensing device that provides real-time angular position data of the shaft of the motor 36. It is to be appreciated that the motor 36 can be any type of AC or DC motor with or without position detecting functionality. It is also to be appreciated that the motor 36 can be configured to allow for free rotation when deenergized such that the kettle 18 is free to be manually operated with the handle 32, such as during malfunction or emergency stoppage, when the motor 36 is deenergized.

Still referring to FIG. 3, a cam 52 can be attached to the driven gear 45 and can rotate together with the driven gear 45 and the spindle 50 as the kettle 18 pivots between the home and dumping positions. The cam 52 can include a home lobe 54 and a dump lobe 56 that correspond to specific angular positions of the kettle 18 when in the home position and the dumping position, respectively. A first proximity sensor 58 can be positioned adjacent to the cam 52 and can interface with the home lobe 54 to facilitate slowing of the kettle 18 as it approaches the home position. A second proximity sensor 60 can be positioned on an opposite side of the cam 52 from the first proximity sensor 58 and can interface with the dump lobe 56 to facilitate slowing of the kettle 18 as it approaches the dumping position.

When the kettle 18 is in the home position, the home lobe 54 can be positioned beneath the first proximity sensor 58 and can activate the first proximity sensor 58. When the kettle 18 rotates away from the home position towards the dumping position, the home lobe 54 rotates away from the first proximity sensor 58 which causes it to be deactivated. When the kettle 18 reaches the dumping position, the dump lobe 56 can be positioned beneath the second proximity sensor 60 to activate the second proximity sensor 60. The first proximity sensor 58 and the second proximity sensor 60 can accordingly provide positional feedback to facilitate slowing of the kettle 18 when approaching or leaving the home and dumping positions, as will be described in further detail below. In some instances, the first and second proximity sensors 58, 60 can be roller type switches. It is to be appreciated, however, that other types of positional sensors can be used to detect the position of the kettle 18, such as optical sensors.

It is to be appreciated that the first proximity sensor 58 and the second proximity sensor 60, together with the cam 52 and the home and dump lobes 54, 56, can collectively form one type of a position detection system that provides positional feedback to the controller 64. The position detection functionality integrated with the motor 36, such as the encoder or the pulse counting capability of the AC stepper motor, can form another type of a position detection system that provides positional feedback to the controller 64. In still other instances, the position detection system can include a combination of proximity sensors and motor-integrated position detection functionality to provide redundant position sensing capabilities.

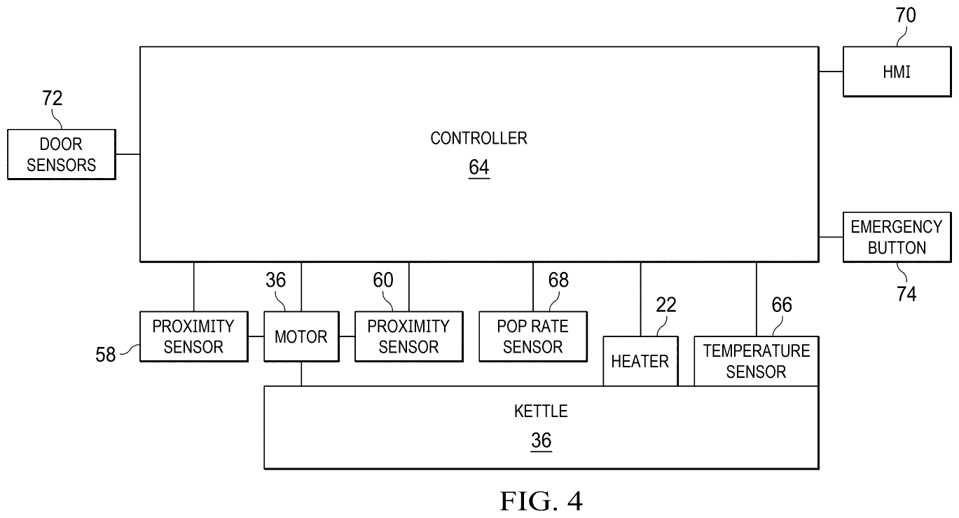

Referring to FIG. 4, a popcorn cooking system of the popcorn machine is illustrated and includes a controller 64 that coordinates the operation of the popcorn machine 10. The controller 64 can be communicatively coupled with the heater 22 to control the heating operation during the popping process. In some instances, the controller 64 can regulate the power supplied to the heater 22 to achieve and maintain desired temperatures within the kettle 18. The controller 64 can also be communicatively coupled with the motor 36 to control the pivoting movement of the kettle 18 between the home position and the dumping position. In some instances, the controller 64 can send control signals to the motor 36 to initiate, stop, or adjust the rotational speed of the motor 36 during the automatic dumping sequence. The controller 64 can also be communicatively coupled with the first and second proximity sensors 58, 60 to receive positional feedback regarding the kettle 18 to facilitate detection of the kettle 18 in the home and dumping positions. The controller 64 can process this positional feedback to coordinate the timing and speed of the movement of the kettle 18 during an automatic dumping sequence.

The controller 64 can be implemented using various hardware and software configurations. In some instances, the controller 64 can include a single integrated microprocessor or digital signal processor that executes software algorithms to facilitate management of the various operations described herein. Alternatively, the controller 64 can utilize a distributed control architecture where separate dedicated processors or microcontrollers might handle discrete tasks. The controller 64 can also incorporate field-programmable gate arrays (FPGAs) or application-specific integrated circuits (ASICs) to achieve high-speed switching control and real-time signal processing capabilities. In some instances, the controller 64 can feature a hybrid configuration that combines general-purpose processors for high-level control functions with dedicated hardware accelerators for time-critical switching operations, providing flexibility in control algorithm implementation while maintaining precise timing requirements for power conversion operations.

A temperature sensor 66 can be communicatively coupled with the controller 64 and configured to sense the temperature of the kettle 18. The temperature sensor 66 can provide temperature data to the controller 64 which can be used to monitor and control the popping process. In some instances, the temperature sensor 66 can be mounted directly to the kettle 18 to provide accurate temperature readings of the kettle 18 during operation. In some instances, the temperature sensor 66 can be part of the heater 22, allowing for integrated temperature monitoring and heating control. The temperature sensor 66 can be any type of temperature sensing devices suitable for monitoring the temperature of the kettle 18, such as, for example, a thermocouple, a resistance temperature detector (RTD), a thermistor, an infrared temperature sensor, or a semiconductor-based temperature sensor.

A pop rate sensor 68 can be communicatively coupled with the controller 64 and configured to detect the popping rate of the popcorn during cooking. In one instance, the pop rate sensor 68 can be an auditory sensor that is configured to detect sounds generated by kernels popping within the kettle 18 and can transmit signal data to the controller 64 for analysis. In these instances, the pop rate sensor 68 can be mounted in the drive assembly 34 to position the pop rate sensor 68 (as illustrated in FIG. 3) in proximity to the kettle 18 for sound detection. The pop rate sensor 68 can be associated with a hole in a cover of the drive assembly 34 (not shown) to allow for sound transmission to the pop rate sensor 68.

The auditory sensor can comprise any type of sensor that can be configured to detect sounds generated in the kettle for detecting a pop rate, such as, for example, a miniature microphone or a piezoelectric sensor. In some instances, the auditory sensor can include signal processing circuitry that filters and amplifies the detected sounds to enhance the detection of popping events while reducing background noise. The auditory sensor can be selected based on factors such as sensitivity, frequency response characteristics, and durability in the operating environment of the popcorn machine 10.

In other instances, the pop rate sensor 68 can include a vibration sensor. The vibration sensor can be an accelerometer or other similar device and can be mounted on or proximate to the kettle 18. As kernels pop during the popping process, the kernels may create vibrations in the kettle 18 that can be detected by the vibration sensor. The vibration sensor can generate signals that can be received by the controller 64 for analysis of the popping rate. In some instances, the pop rate sensor 68 can include both the auditory sensor and the vibratory sensor to enhance overall accuracy of the popping detection system. The controller 64 can receive signals from both sensors to provide redundant sensing capabilities and improve the reliability of determining when the popping process is complete.

The temperature sensor 66 and the pop rate sensor 68, either alone or in combination, can form a sensor system that monitors operational parameters during the popping process. Generally speaking, the sensor system can provide data to the controller 64 to enable the controller 64 to determine when the popping process is complete. In some instances, the sensor system can include additional or alternative sensors beyond the temperature sensor 66 and pop rate sensor 68, such as, for example, humidity sensors, vibration sensors, acoustic sensors, or power consumption sensors, as described further below, to monitor additional/alternative operational parameters.

A human-machine interface (HMI) 70 can be communicatively coupled with the controller 64 and can serve as the interface between a user and the popcorn machine 10. The HMI 70 can be configured to display information to the user and receive inputs from the user during operation of the popcorn machine 10. In some instances, the HMI 70 can include a display screen that presents operational status information, temperature readings, and process notifications to the user, while also providing input mechanisms such as push buttons, touchscreen controls, or other user interface elements that allow the user to interact with and control various aspects of the popcorn machine 10. The HMI 70 can include any of a variety of digital or analog interfaces that allow for individual or collective control of operational parameters. For example, the HMI 70 can include physical controls such as buttons, knobs, switches, or dials, that enable users to adjust settings for various operational parameters of the popcorn machine 10, as described further herein.

The HMI 70 can be positioned on the housing 12 of the popcorn machine 10 in a location that provides convenient access for the user during operation. The HMI 70 is shown in FIG. 1 to be mounted on a front panel of the housing 12 but can be mounted in any of a variety of suitable alternative locations where the user can easily view displayed information and access control functions. In some instances, the HMI 70 can be implemented as a remote device that is physically separate from the popcorn machine 10, such as a cellular phone, tablet computer, laptop computer, or other portable computing device that communicates with the controller 64 through wireless communication protocols. The remote HMI implementation can allow users to monitor and control the popcorn machine 10 from a distance, enabling operators to manage multiple machines or perform other tasks while maintaining oversight of the popping process.

Still referring to FIG. 4, the popcorn machine 10 can include an emergency button 74 that provides an immediate shutdown mechanism for the popcorn machine 10 in response to emergency situations or safety concerns. The emergency button 74 can be communicatively coupled with the controller 64 to enable rapid deactivation of the machine's operational systems when the emergency button 74 is activated by a user. When the emergency button 74 is activated, the controller 64 can deactivate the heater 22, deenergize the motor 36, and can deenergize other powered components (e.g., a stirrer) to bring the system to a safe state. When the emergency button is activated, the controller 64 can notify the user via the HMI 70 of the emergency shutdown and can display component status information. As illustrated in FIG. 1, the emergency button 74 can be mounted on the exterior of the housing 12 in an easily accessible and prominent position to enable quick activation when needed.

The popcorn cooking system can be responsible for automating the operation of the popcorn machine 10 such that manual monitoring and intervention is significantly reduced or even eliminated. The popcorn cooking system can implement a two-stage process that includes a cooking sequence followed by an automatic dumping sequence. The cooking sequence can automate the cooking process of the popcorn by monitoring the popping rate of the popcorn and the thermal conditions (or other operational parameters) within the kettle 18 to determine whether the popcorn has been sufficiently cooked. The automatic dumping process can automate the dumping of the popped popcorn from the kettle 18 onto an underlying tray when the popcorn has been sufficiently cooked. The integration of these two sequences can provide a fully automated popcorn production system that can operate with minimal user oversight. This automated approach can enhance consistency in the final product while reducing the labor requirements typically associated with manual popcorn production operations.

The cooking sequence can be initiated when the popcorn popping process is started. This can occur when a user initiates the popcorn popping process through the HMI 70, where the user can select a start command or activate a popping cycle through touchscreen controls, buttons, or other input mechanisms provided by the HMI 70 or through some other initiation process. The HMI 70 can present the user with options to begin the cooking sequence, and upon receiving the user's input, can initialize the cooking sequence. When the cooking sequence is initialized, the controller 64 can activate the heater 22 to begin heating the kettle 18 to a predetermined initialization temperature. The initialization temperature can be understood to be the temperature at which the kettle should be preheated before adding any product to the kettle and typically can be between about 400-420 degrees F. The initialization temperature can be preset by the manufacturer or can be customized by a user via the HMI 70.

The controller 64 can monitor the temperature of the kettle 18 and, once it reaches the initialization temperature, can cause a notification to be generated for a user to add product to the kettle 18. This notification can be in the form of a message, lights, audible alarms or other features on the HMI 70 or other notification device. When the product is added to the kettle 18, it can cause the temperature of the kettle 18 to drop significantly. The controller 64 can recognize this temperature drop as an indication that the cooking process has begun. In response, the controller 64 can continue heating the kettle 18 and can detect the popping rate of the popcorn. As the popcorn continues to cook, the controller 64 can compare the popping rate to a threshold popping rate (e.g., a threshold popping rate value) and can compare the temperature of the kettle to a threshold dump temperature (e.g., a threshold temperature value). The threshold popping rate can be the popping rate of the popcorn that indicates when the popcorn has been sufficiently popped, as discussed in further detail below. The threshold dump temperature can be understood to be the temperature of the kettle 18 that, once reached, indicates when the popcorn has been sufficiently popped, as discussed in further detail below. When the popping rate reaches the threshold popping rate and the temperature of the kettle 18 reaches the threshold dump temperature, the automatic dumping sequence can be implemented at which point the kettle 18 can be automatically dumped to empty the contents of the kettle 18 onto an underlying tray. Further details about the automatic dumping sequence are provided below.

The detection of the popping rate of the popcorn during the cooking sequence will now be described in further detail. During the cooking sequence, a reduction in the popping rate of the popcorn can indicate that the popcorn has been sufficiently cooked. For example, as the popping process progresses, the popcorn kernels may initially pop at an increasing rate as the temperature rises, reaching a peak popping rate, and then the popping rate may decline as fewer unpopped kernels remain in the kettle 18. This decline in popping rate can serve as an indicator that the popping process is nearing completion. The controller 64 can accordingly monitor the popping rate of the popcorn (e.g., via the pop rate sensor 68) and can compare the popping rate to the threshold popping rate to detect when the popping rate of the popcorn is at or below the threshold popping rate (e.g., the popping rate has satisfied the threshold popping rate). The threshold popping rate can therefore be used by the controller 64 as one indicator that the popcorn has been sufficiently popped.

The threshold popping rate can be established through various methods. In some instances, the threshold popping rate can be a preset value that is typically set by the manufacturer. In other instances, the threshold popping rate can be selected by a user via the HMI 70 to allow for user customization of the final product characteristics based on preferences or specific requirements such as, for example, to select the completion level of the popcorn (e.g., rare, medium, and well done).

In other instances, the threshold popping rate can be dynamically selected during the cooking sequence as a function of the real-time characteristics of the popcorn. For example, the threshold popping rate can be selected using a rolling average algorithm that identifies a peak popping rate and applies a scaling factor. In such an example, the controller 64 can sample the signal from the pop rate sensor at a sampling rate (e.g., twice per second) that captures the popping events with sufficient temporal resolution. The controller 64 can implement a rolling average of a select group of previous samples (e.g., the previous 100 samples) to provide a stable measurement of the trend of the popping rate. The peak popping rate can be determined by comparing the current rolling average to previous rolling averages, and once the rolling averages start to decline, the peak popping rate can be identified. Once the peak popping rate is determined, the peak popping rate can be multiplied by a scaling factor to determine the threshold popping rate value. In some instances, the peak popping rate can be multiplied by a scaling factor of 0.7 to determine the threshold popping rate value, though other scaling factors may be used depending on the desired level of completion or specific popcorn characteristics. This dynamic approach can automatically adjust the threshold popping rate based on the actual popping behavior of each batch, accounting for variations in kernel type, age, moisture content, and other factors that may affect the popping process.

In some instances, the controller 64 can be equipped with learning mode functionality that allows a user to select the threshold popping rate from a test a batch of popcorn. When the controller 64 is placed in the learning mode and the test batch is popping, the user can audibly monitor the popping rate. When a desired popping rate is achieved, the user can interface with the HMI 70 to cause the system to store the currently detected popping rate as the threshold popping rate for future batches.

The detection of the temperature of the popcorn during the cooking sequence will now be described in further detail. The temperature of the kettle 18 can be continuously or periodically monitored by the temperature sensor 66 during the cooking sequence and can be compared to the threshold dump temperature to detect when the temperature of the popcorn is at or above the threshold temperature (e.g., the temperature has satisfied the threshold popping rate) to determine whether the temperature indicates that the popcorn has been sufficiently popped. The threshold dump temperature can represent a temperature at which the popping process has progressed to a point where the kernels have been adequately heated and transformed into popped popcorn.

The threshold dump temperature can be established through various methods. In some instances, the threshold dump temperature can be a preset value that is typically set by the manufacturer. In other instances, the threshold dump temperature can be selected and customized by a user through the HMI 70 which can allow users to input a desired threshold dump temperature value based on their preferences for popcorn completion or specific requirements for different types of kernels.

During the cooking sequence, the controller 64 can continuously monitor both the popping rate and the temperature of the kettle 18 simultaneously. This dual-threshold approach can provide enhanced accuracy in determining when the popcorn has been sufficiently popped compared to relying on a single parameter. In some cases, the popping rate may reach the threshold popping rate before the threshold dump temperature is satisfied, or conversely, the threshold dump temperature may be satisfied before the threshold popping rate is met. The controller 64 can continue monitoring both parameters until both thresholds are simultaneously satisfied.

When the controller 64 determines that the detected popping rate is at or below the threshold popping rate and the detected kettle 18 temperature is at or above the threshold dump temperature, the controller 64 can conclude that the popping process is complete. In some cases, the controller 64 can implement a brief verification period to confirm that both threshold conditions remain satisfied for a predetermined duration before proceeding with the dumping sequence. Once both threshold conditions are confirmed to be satisfied, the controller 64 can automatically initiate the dumping sequence by deactivating the heater 22 to cease further heating of the kettle 18 and activating the motor 36 to pivot the kettle 18 from the home position to the dumping position. The automatic initiation of the dumping sequence can eliminate the need for manual intervention by an operator, thereby reducing the potential for human error and improving the consistency of the popping process.

In some cases, the controller 64 can provide notification through the HMI 70 that the dumping sequence is about to commence. The notification can include visual indicators, audible alerts, or display messages to inform the operator that the automatic dumping sequence is beginning. This notification can allow operators to be aware of the status of the popcorn machine 10 while maintaining the automated operation of the popping and dumping process.

During the automatic dumping sequence, the controller 64 can be configured to monitor the status of the access doors 16 to prevent the automatic dumping sequence from occurring while the access doors 16 are opened. As illustrated in FIGS. 1 and 4, door sensors 72 can be provided at the access doors 16 that monitor the status of the access doors 16. The door sensors 72 can be communicatively coupled with the controller 64 (see FIG. 4) to provide real-time status information regarding the position of the access doors 16. During the automatic dumping sequence, if the door sensors 72 indicate that the access doors 16 have been opened, the controller 64 can immediately halt operation of the motor 36 to prevent potential hazards associated with movement of the kettle 18. When the motor 36 is halted due to the opening of the access doors 16, the controller 64 can notify the user via the HMI 70 that the movement of the kettle 18 has been interrupted. This notification can include a message instructing the user to close the access doors 16 to resume the automatic dumping sequence. In some cases, the HMI 70 can display visual indicators or generate audible alerts to draw attention to the interrupted state of the dumping operation. Once the access doors 16 are closed and the door sensors 72 confirm that the access doors 16 are in the closed position, the controller 64 can allow the automatic dumping sequence to resume.

Additional details regarding the automatic dumping sequence will now be described. In some instances, the speed of the kettle 18 can be slowed when approaching the home or dumping positions to prevent abrupt stopping of the kettle 18 that could potentially damage the kettle 18 or other components. When the motor 36 includes position detection functionality, such as when an AC stepper motor or a DC motor with an encoder is utilized, the controller 64 can determine the position of the kettle 18 as a function of the position of the shaft of the motor 36. Before the kettle 18 is pivoted away from either the home position or the dumping position, the controller 64 can register the current home position or dumping position as a function of which of the first or second proximity sensors 58, 60 are activated. When the kettle 18 is in either of the home or dumping positions, the home lobe 54 or the dump lobe 56 can activate the first proximity sensor 58 or the second proximity sensor 60, respectively. By registering the activation of either of the first and second proximity sensors 58, 60 before initiating movement, the controller 64 can determine both the starting position and target destination, enabling calculation of the required rotational direction and distance for the motor 36 to cause the kettle 18 to pivot to the desired home or dumping position. This registration step can also allow the controller 64 to verify that the kettle 18 is properly positioned at either of the home or dumping positions before pivoting the kettle 18 which can help alleviate potential positioning errors during positioning of the kettle 18.

When the kettle 18 is moved from either the home or dumping positions, the controller 64 can monitor the position of the kettle 18 via the motor 36 until it reaches a predetermined position for slowing down the full speed of the kettle 18. This predetermined position is reached before the home and dump lobes 54, 56 make contact with the respective first or second proximity sensors 58, 60. The predetermined position can be established as a preset distance from the target position or can be dynamically calculated based on operational parameters such as rotational speed, kettle 18 inertia, and motor 36 deceleration characteristics. The controller 64 can also combine preset and calculated approaches by using a baseline preset distance and applying correction factors based on real-time operational data to optimize positioning accuracy. Once the kettle 18 is slowed, it continues to pivot until the home or dump lobes 54, 56 activate the first or second proximity sensors 58, 60, at which point the motor 36 is deactivated and the inertia of the kettle 18 brings it to the home or dumping position.

In other instances, the controller 64 can rely solely on detecting the position of the kettle 18 from the position of the motor 36 and can control the slowing and stopping of the kettle 18 without the use of the first and second proximity sensors 58, 60 or the cam 52. In these instances, the controller 64 can maintain a position counter that tracks the angular displacement of the shaft of the motor 36 from either the home position or the dumping position. As the kettle 18 pivots towards either the home position or the dumping position, the controller 64 can decrement or increment the position counter based on the direction of rotation and the position of the kettle 18. As the kettle 18 approaches the home or dumping positions, the controller 64 can compare the current position counter value to the predetermined position for the target position. When the difference between the current position and the target position falls below a predetermined threshold distance, the controller 64 can reduce the speed of the motor 36 from full speed to facilitate a controlled deceleration of the kettle 18 into either the home or dumping positions. This countdown approach can allow the controller 64 to anticipate when the kettle 18 is nearing the home position or the dumping position and initiate speed reduction at an appropriate time to achieve smooth positioning. The predetermined threshold distance for initiating speed reduction can be preset, selected by the user via the HMI 70, or calibrated based on factors such as the inertia of the kettle 18, the characteristics of the drive assembly 34, and the desired positioning accuracy.

In still other instances, the controller 64 can rely solely on the first and second proximity sensors 58, 60 and the home and dump lobes 54, 56 to determine when to begin slowing the kettle 18 until it eventually reaches the home or dumping positions. This approach can be particularly useful when the motor 36 does not include position detection functionality such as encoders or stepper motor pulse counting. In these instances, when the kettle 18 is rotating from the dumping position towards the home position, the first proximity sensor 58 can detect the presence of the home lobe 54 before the kettle 18 reaches the home position, which can signal to the controller 64 to reduce the speed of the motor 36 from full speed until it reaches the home position. Similarly, when the kettle 18 is rotating from the home position towards the dumping position, the second proximity sensor 60 can detect the presence of the dump lobe 56 before the kettle 18 reaches the dumping position, which can signal to the controller 64 to slow down the rotation of the motor 36 from full speed until it reaches the dumping position. It is to be appreciated that the reduced speed and/or full speed of the kettle 18 can be preset or selected by a user via the HMI 70.

In some instances, when the kettle 18 initially reaches the dumping position as part of the automatic dumping sequence, the popcorn popping system can enter a dump mode where the position of the kettle 18 is repeatedly oscillated. The dump mode can facilitate adequate emptying of the kettle 18 and can help ensure that unpopped kernels or other residual materials are properly dispensed from the kettle 18.

When in the dump mode, the kettle 18 can be oscillated in either a full dump mode or a juddering mode. In the full dump mode, the kettle 18 can be repeatedly oscillated between the dumping position and the home position (e.g., at least twice). This full oscillation can facilitate thorough emptying of the kettle 18 contents by utilizing the complete range of motion available to the kettle 18.

When in the juddering mode, the kettle 18 can be juddered by repeatedly and rapidly pivoting the kettle 18 slightly away from the dumping position to a judder position (e.g., about 5 degrees away from the dumping position) and back into the dumping position. This juddering motion can facilitate thorough emptying of the kettle 18 by effectively shaking the kettle 18.

The selection between the full dump mode and the juddering mode can be selected by the user via the HMI 70. This user selection capability can allow operators to customize the dumping process based on specific operational preferences or the characteristics of the particular batch of popcorn being processed. The HMI 70 can provide interface options that enable users to choose the dump mode that may be most suitable for their particular application or desired level of kettle 18 emptying.

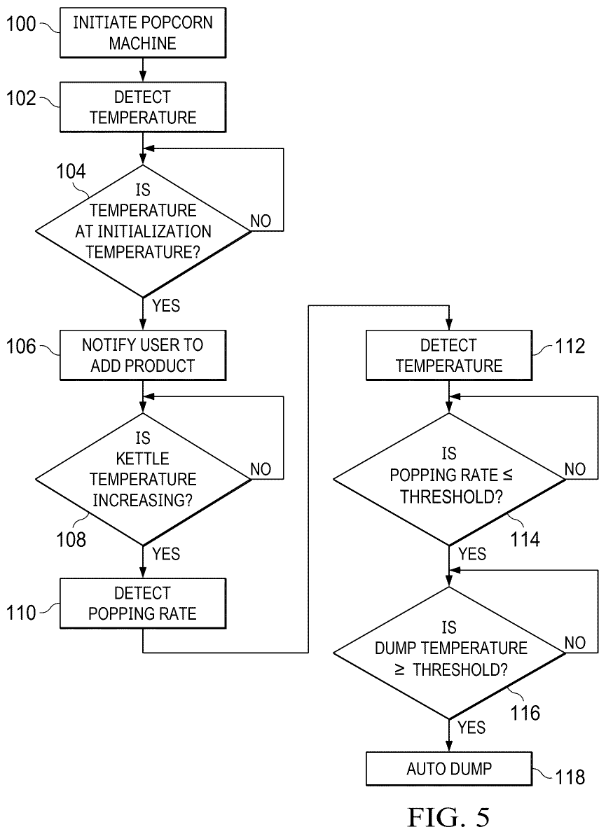

Referring now to FIG. 5, a flowchart is depicted that illustrates one example of the implementation of the cooking sequence and the automatic dumping sequence of the popcorn machine 10. The popcorn machine 10 can first be initiated (100) to start the cooking sequence. The temperature of the kettle 18 is detected (102) to determine whether the kettle 18 has reached the initialization temperature (104). Once the initialization temperature has been reached, the controller 64 can notify the user to add product to the kettle 18 (106). As mentioned above, when the product is added, the temperature of the kettle 18 drops. The controller 64 can continue to monitor the temperature of the kettle 18 while it is reheating. The controller 64 can wait until the temperature of the kettle 18 begins to increase before comparing the popping rate to the threshold popping rate and the temperature to the threshold dump temperature (108). Waiting for the temperature to increase can ensure that the popping process has actually commenced and that the kettle 18 has recovered from the initial temperature drop caused by adding the product. This waiting period can help prevent premature evaluation of the popping conditions that could occur if the controller 64 began monitoring the popping rate while the kettle 18 is still in the initial heating phase after product addition. By waiting for the temperature to increase, the controller 64 can more accurately assess the actual popping behavior and thermal conditions during the active popping phase, which can improve the reliability of the determination of when the popcorn has been sufficiently popped.

Once the temperature of the kettle 18 begins to increase, the controller 64 can begin detecting the popping rate (110) and can continue detecting the temperature of the kettle (112). As the popping process continues, the controller 64 can compare the detected popping rate to the threshold popping rate (114) and can compare the detected temperature to the threshold dump temperature (116). The comparison of the detected popping rate to the threshold popping rate and the comparison of the detected temperature to the threshold dump temperature, while depicted sequentially in the flowchart, can occur simultaneously during operation of the popcorn machine 10. If the popping rate has not reached the threshold popping rate or the temperature of the kettle 18 has not reached the threshold dump temperature, the controller 64 can continue to monitor both parameters. Once the popping rate is at or below the threshold popping rate and the temperature of the kettle 18 is greater than or equal to the threshold dump temperature, the automatic dumping sequence is performed to dump the popped popcorn from the kettle 18.

In some instances, the controller 64 can be equipped with a timeout function that monitors the duration of the cooking sequence and aborts the cooking sequence automatically when the cooking sequence exceeds a predefined time limit. This timeout function can provide a fail-safe mechanism that prevents the cooking sequence from continuing indefinitely in cases where the threshold popping rate and/or the threshold dump temperature is/are not met within a reasonable timeframe.

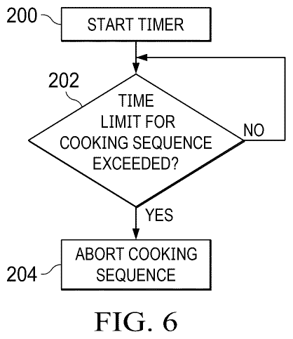

Referring now to FIG. 6, a flowchart is depicted that illustrates an example of the timeout function implemented by the controller 64. First, when the cooking sequence is initiated, the controller 64 can start a timer (200) that effectively runs in the background during the cooking sequence. The controller 64 continuously compares the elapsed time of the timer to a predefined time limit (202). If the predefined time limit is not reached before the dumping sequence is initiated, then the cooking sequence is allowed to proceed normally. However, if the predefined time limit is reached before the automatic dumping sequence is initiated, the controller 64 can abort the cooking sequence (204) which can include deactivating the heater 22 and any other components that may be responsible for popping the popcorn. After the cooking sequence is aborted, the user can remove the contents of the kettle 18 and start the process over again if desired. This time-based monitoring can prevent potential safety issues or equipment damage that could result from an excessively long cooking cycle. It is to be appreciated that the predefined time limit can be preset a preset value that is selected by the manufacturer or can be selected by a user via the HMI 70 to allow for customization based on specific operating conditions or preferences.

While the embodiments described above utilize both the popping rate and the dump temperature as the operational parameters that are used for determining when to initiate the dumping sequence, it is to be appreciated that the controller 64 can utilize any of a variety of other operational parameters, either alone or in combination, to determine whether the popping process is complete and the dumping sequence should be executed. These alternative operational parameters can provide additional or substitute indicators of popping completion that can enhance the accuracy and reliability of the automated dumping determination.

The operational parameters that can be monitored by the controller 64 to determine when to execute the dumping sequence can be detected by various additional or alternative sensors that can form part of the sensor system. These operational parameters can include, but are not limited to: the rate of temperature change in the kettle 18 over time; the total number of detected popping events; the peak popping rate achieved during the cooking sequence; the duration of time that the popping rate remains below a threshold value; the moisture content or humidity level within the popping chamber 14; the power consumption of the heater 22 during the cooking sequence; the acoustic frequency spectrum of the popping sounds; the vibration amplitude or frequency detected by a vibration sensor; the rate of change of the popping rate over time; the temperature differential between the kettle 18 and the popping chamber 14; or any combination thereof. The controller 64 can be configured to apply weighting factors to multiple operational parameters and calculate a composite score that is compared to a threshold value to determine when the popping process is sufficiently complete to initiate the dumping sequence.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

1. A popcorn machine, comprising:
a kettle configured to cook popcorn kernels;
a heater configured to heat the kettle;
a first sensor configured to detect a first operational parameter during cooking of the popcorn kernels;
a second sensor configured to detect a second operational parameter during cooking of the popcorn kernels;
a drive assembly operatively coupled to the kettle and configured to automatically dump the kettle; and
a controller communicatively coupled to the first sensor, the second sensor, and the drive assembly, the controller configured to:
compare the first operational parameter to a first threshold value;
compare the second operational parameter to a second threshold value; and
activate the drive assembly to automatically dump the kettle when both the first operational parameter satisfies the first threshold value and the second operational parameter satisfies the second threshold value.

2. The popcorn machine of claim 1, wherein the first sensor is a pop rate sensor configured to detect a popping rate of the popcorn kernels.

3. The popcorn machine of claim 1, wherein the second sensor is a temperature sensor configured to detect a temperature of the kettle.

4. The popcorn machine of claim 2, wherein the pop rate sensor comprises an auditory sensor configured to detect sounds generated by the popcorn kernels popping within the kettle.

5. The popcorn machine of claim 4, wherein the auditory sensor comprises a microphone positioned adjacent to the kettle.

6. The popcorn machine of claim 2, wherein the pop rate sensor comprises a vibration sensor configured to detect vibrations caused by the popcorn kernels popping within the kettle.

7. The popcorn machine of claim 3, wherein the controller is configured to wait for the temperature of the kettle to begin increasing before detecting the popping rate.

8. The popcorn machine of claim 2, further comprising a human-machine interface communicatively coupled to the controller, wherein the first threshold value is a threshold popping rate that is user selectable via the human-machine interface.

9. The popcorn machine of claim 3, further comprising a human-machine interface communicatively coupled to the controller, wherein the second threshold value is a threshold dump temperature that is user selectable via the human-machine interface.

10. The popcorn machine of claim 2, wherein the controller is configured to dynamically determine the first threshold value as a threshold popping rate during cooking of the popcorn kernels.

11. The popcorn machine of claim 10, wherein the controller is configured to dynamically determine the threshold popping rate by:
sampling the popping rate at a predetermined sampling rate;
calculating a rolling average of a predetermined number of previous samples;
identifying a peak popping rate from the rolling averages; and
multiplying the peak popping rate by a scaling factor to determine the threshold popping rate.

12. The popcorn machine of claim 2, wherein the controller is configured to monitor a duration of cooking and abort the cooking when the duration exceeds a predefined time limit.

13. A popcorn machine, comprising:
a kettle pivotable between a home position and a dumping position;
a motor operatively coupled to the kettle and configured to rotate the kettle between the home position and the dumping position;
a position detection system configured to detect when the kettle approaches the dumping position; and
a controller communicatively coupled to the motor and the position detection system, the controller configured to:
control the motor to rotate the kettle from the home position toward the dumping position at a first speed;
receive a signal from the position detection system when the kettle approaches the dumping position;
reduce the rotational speed of the kettle from the first speed to a second speed that is slower than the first speed when the kettle approaches the dumping position; and
stop the kettle at the dumping position.

14. The popcorn machine of claim 13, wherein the position detection system comprises a proximity sensor configured to detect a lobe on a cam that rotates with the kettle.

15. The popcorn machine of claim 14, wherein the proximity sensor is positioned adjacent to the cam and the lobe activates the proximity sensor when the kettle approaches the dumping position.

16. The popcorn machine of claim 13, wherein the controller is further configured to oscillate the kettle in a dump mode after stopping the kettle at the dumping position.

17. A popcorn machine, comprising:
a kettle pivotable to a dumping position;
a drive assembly operatively coupled to the kettle and configured to automatically pivot the kettle to the dumping position;
a sensor system configured to determine that a popping process is complete; and
a controller communicatively coupled to the drive assembly and the sensor system, the controller configured to:
receive a signal from the sensor system indicating that the popping process is complete;
activate the drive assembly to automatically pivot the kettle to the dumping position;
enter a dump mode after the kettle reaches the dumping position; and
oscillate the kettle while in the dump mode to facilitate emptying of contents from the kettle.

18. The popcorn machine of claim 17, wherein the controller is configured to oscillate the kettle by pivoting the kettle between the dumping position and a home position at least one more time.

19. The popcorn machine of claim 17, wherein the controller is configured to oscillate the kettle by juddering the kettle through repeatedly pivoting the kettle between the dumping position and a judder position that is positioned slightly away from the dumping position.

20. The popcorn machine of claim 17, wherein the sensor system comprises a pop rate sensor configured to detect a popping rate of the popcorn kernels and a temperature sensor configured to detect a temperature of the kettle.

21-42. (canceled)
